(19) United States
(12) Patent Application Publication
(10) Pub. No.: US 2016/0365779 A1
(43) Pub. Date: Dec. 15, 2016

(54) ROTOR, MOTOR AND METHOD OF MANUFACTURING THE ROTOR

(71) Applicant: NIDEC TECHNO MOTOR CORPORATION, Minami-ku (JP)

(72) Inventors: Akira WATANABE, Minami-ku (JP); Satoru YAMAMOTO, Minami-ku (JP)

(21) Appl. No.: 15/175,498

(22) Filed: Jun. 7, 2016

(30) Foreign Application Priority Data
Jun. 10, 2015 (JP) 2015-117103

(51) Int. Cl. H02K 15/03; H02K 5/02; H02K 3/18; H02K 1/28; H02K 1/27; H02K 1/14

(52) U.S. Cl. CPC H02K 15/03; H02K 1/2706; H02K 1/14; H02K 3/18; H02K 1/28; H02K 5/02

(57) ABSTRACT

A rotor which rotates on a vertically extending center axis may include a cylindrical rotor core made of a magnetic material; a plurality of magnets which are provided on an outer circumferential surface of the rotor core; and a resin portion which holds the rotor core and the magnets. The resin portion may include an outer cover portion which covers a radially outer side surface of the magnets, and the outer cover portion may include a groove portion which is recessed radially inward from a radially outer surface and further extends in an axial direction; and a wall portion adjacent to the groove portion in a circumferential direction.

### CROSS REFERENCE TO RELATED APPLICATION

The present application claims priority under 35 U.S.C. §119 to Japanese Application No. 2015-117103 filed Jun. 10, 2015, the entire content of which is incorporated herein by reference.

### FIELD OF THE DISCLOSURE

The present disclosure relates to a rotor, a motor and a method of manufacturing the rotor.

### DESCRIPTION OF THE RELATED ART

In the past, a so-called inner rotor type motor has been known, in which a rotor is provided on a radially inner side of a stator. The rotor used in the inner rotor type motor may include, for example, a rotor yoke, a plurality of permanent magnets and a mold resin. Further, in the rotor, a method of pouring resin into an outer circumferential end portion of the permanent magnet and both axial end portions is used to fix the permanent magnets to a surface of the rotor yoke.

In the above-described structure of the past, only the vicinity of both circumferential end portions of the permanent magnets was covered by the resin. For this reason, when the motor is sped up and the centrifugal force applied to the permanent magnets is increased, there is a possibility that a known, conventional structure may not be able to prevent the permanent magnets from scattering.

In order to cope with a further speed-up of the motor, covering a wider region of a radially outer surface of the permanent magnets with the resin may be considered. However, when a radial distance between the permanent magnets and the stator is increased, efficiency of the motor is reduced. Accordingly, in terms of the efficiency of the motor, the thickness of the resin covering the permanent magnets needs to be reduced. To do so, when injection molding of the mold resin is performed, a gap between the radially outer surface of the permanent magnets and an inner circumferential surface of a mold needs to be narrowed.

However, it is difficult to pour the resin stably into such a narrow gap. Therefore, the gap may not be filled with the resin. Further, when there is air remaining in the narrow gap and the air is compressed to a high temperature, the resin provided around the narrow gap may be deteriorated. Further, due to the failure to fill the gap with the resin or the deteriorated resin, there is a possibility that the resin may be partially peeled off from the permanent magnets after manufacture.

### SUMMARY OF THE DISCLOSURE

A first exemplary embodiment according to the present disclosure is an inner rotor type motor and a rotor which rotates on a vertically extending center axis, the rotor comprising: a tube-shaped rotor core made of a magnetic material; a plurality of magnets which are provided on an outer circumferential surface of the rotor core; and a resin portion which holds the rotor core and the magnets, the resin portion including an outer cover portion which covers a radially outer side surface of the magnets, the outer cover portion including a groove portion which is concaved radially inward from a radially outer surface, and further, extends in an axial direction; and a wall portion adjacent to the groove portion in a circumferential direction.

A second exemplary embodiment according to the present disclosure is a method of manufacturing a rotor comprising a tube-shaped rotor core which is made of a magnetic material and has its center on a vertically extending center axis; a plurality of magnets which are provided on an outer circumferential surface of the rotor core; and a resin portion which holds the rotor core and the magnets, the method comprising the steps of: a) disposing the rotor core and the plurality of magnets in a cavity portion formed by a pair of upper and lower molds; b) pouring molten resin into the cavity portion; and c) forming the resin portion by solidifying the molten resin. At least one of the molds in the pair of the upper and lower molds includes a plurality of protrusions which protrude radially inward from an inner circumferential surface which defines the cavity portion, while extending in an axial direction, wherein, in step a), the plurality of protrusions contact or radially face each of the radially outer side surfaces of the plurality of magnets across a slight gap, and in step c), a groove portion is formed in the resin portion by the plurality of protrusions.

The above and other elements, features, steps, characteristics and advantages of the present disclosure will become more apparent from the following detailed description of the embodiments with reference to the attached drawings.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view of a rotor according to a first exemplary embodiment.

FIG. 2 is a top view which illustrates a state of the rotor according to the first exemplary embodiment when injection molding is performed.

FIG. 3 is a vertical cross-sectional view of a motor according to a second exemplary embodiment.

FIG. 4 is a perspective view of a rotor according to the second exemplary embodiment.

FIG. 5 is a perspective view of a rotor core and a plurality of magnets according to the second exemplary embodiment.

FIG. 6 is a cross-sectional view of the rotor according to the second exemplary embodiment.

FIG. 7 is a vertical cross-sectional view of the rotor according to the second exemplary embodiment.

FIG. 8 is a flowchart which illustrates a manufacturing sequence of the rotor according to the second exemplary embodiment.

FIG. 9 is a vertical cross-sectional view which illustrates a state when injection molding is performed according to the second exemplary embodiment.

FIG. 10 is a top view which illustrates a state when injection molding is performed according to the second exemplary embodiment.

### DETAILED DESCRIPTION

Herein, exemplary embodiments of the present disclosure will be explained with reference to the attached drawings. Further, herein, a direction parallel to a center axis of a rotor is referred to as “axial direction,” a direction orthogonal to the center axis of the rotor is referred to as “radial direction,” and a direction along a circular arc having its center on the center axis of the rotor is referred to as “circumferential direction.” Moreover, in the following embodiments, the shapes and positional relations of the elements will be explained by referring to the axial direction as upper and lower directions. It is to be understood that this definition of the upper and lower directions is not intended to define a particular direction when the rotor and the motor are actually manufactured or used.

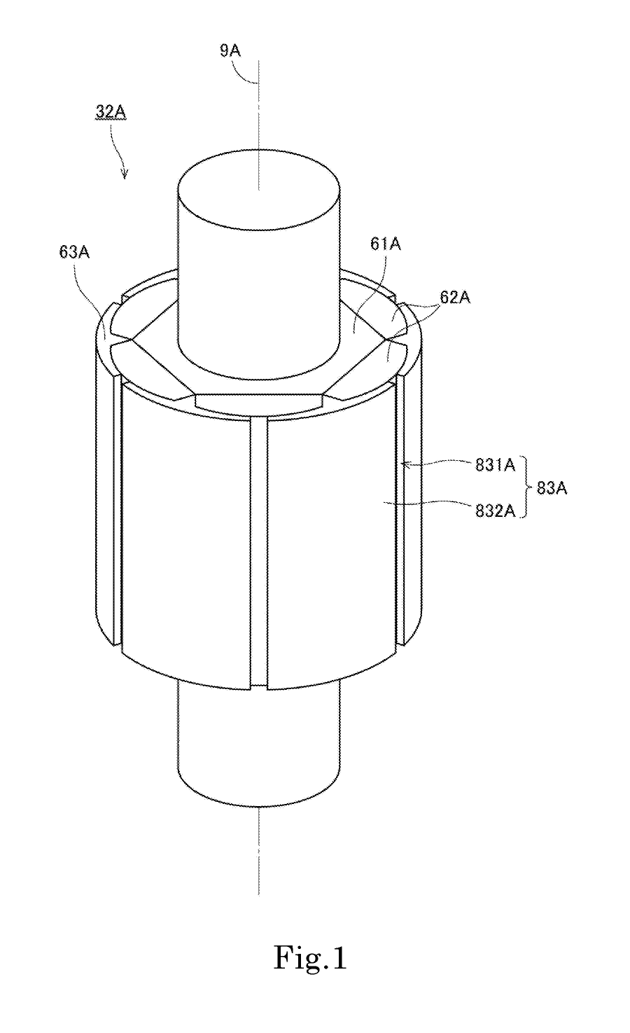

FIG. 1 is a perspective view of a rotor 32A according to a first exemplary embodiment. The rotor 32A is used in an inner rotor type motor. When the motor is driven, the rotor 32A rotates on a vertically extending center axis 9A.

As illustrated in FIG. 1, the rotor 32A includes a rotor core 61A, a plurality of magnets 62A and a resin portion 63A. The rotor core 61A is a tube-shaped magnetic material having its center on the center axis 9A. The plurality of magnets 62A is provided on an outer circumferential surface of the rotor core 61A. The rotor core 61A and the plurality of magnets 62A are held by being covered with the resin portion 63A.

The resin portion 63A includes an outer cover portion 83A which covers a radially outer side surface of the magnets 62A. The outer cover portion 83A includes a groove portion 831A and a wall portion 832A. The groove portion 831A is concaved radially inward from a radially outer side surface of the outer cover portion 83A, and extends in the axial direction. The wall portion 832A is adjacent to the groove portion 831A in the circumferential direction. When the motor is driven, centrifugal force is applied to the magnets 62A; however, the wall portion 832A of the outer cover portion 83A prevents the magnets 62A from scattering out to a radially outer side.

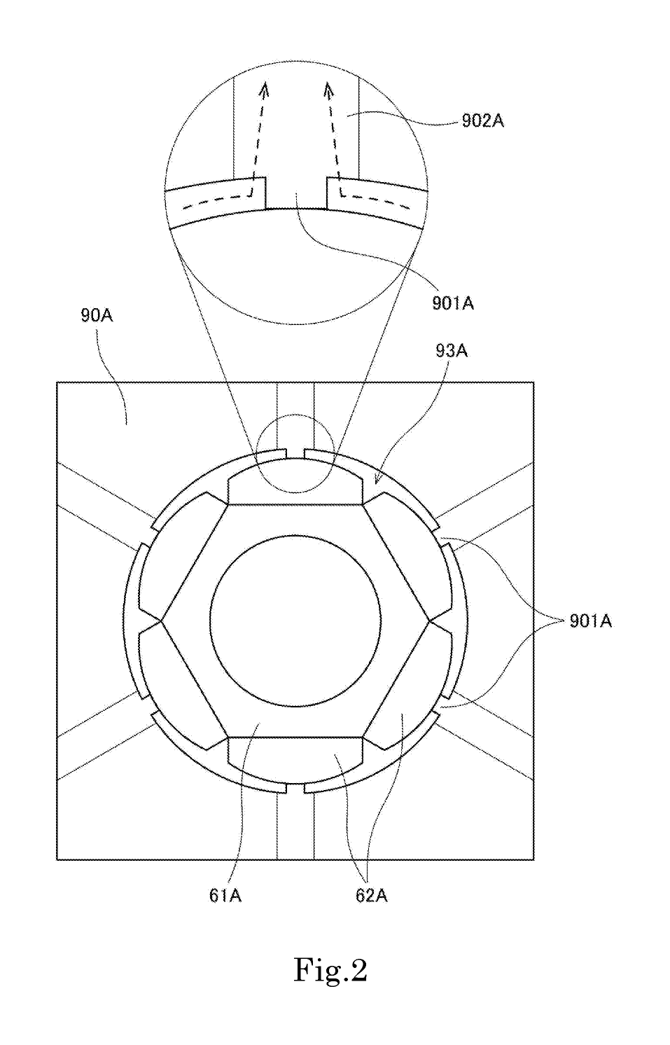

FIG. 2 is a top view which illustrates a state when injection molding of the resin portion 63A is performed in the manufacturing process of the rotor 32A. When injection molding of the resin portion 63A is performed, first, the rotor core 61A and the plurality of magnets 62A are disposed in a cavity portion 93A formed by a pair of upper and lower molds 90A. Next, molten resin is poured into the cavity portion 93A inside the upper and lower molds 90A. After that, by solidifying the molten resin, the resin portion 63A is formed.

As illustrated in FIG. 2, a plurality of protrusions 901A is provided in the pair of the upper and lower molds 90A. Each of the protrusions 901A protrudes radially inward from an inner circumferential surface which defines the cavity portion 93A of the upper and lower molds 90A, while extending in the axial direction. When the rotor core 61A and the plurality of magnets 62A are disposed inside the upper and lower molds 90A, the plurality of protrusions 901A contact or radially face each of the radially outer side surfaces of the plurality of magnets 62A across a slight gap. For this reason, when molten resin is poured into the cavity portion 93A inside the upper and lower molds 90A and solidified, the above-described groove portion 831A is defined by the plurality of protrusions 901A.

Further, in a space between an inner circumferential surface of the upper and lower molds 90A and the magnets 62A, a narrow space where it is difficult to pour molten resin into is made smaller by the protrusions 901A. When molten resin is poured into the cavity portion 93A inside the upper and lower molds 90A, air between an inner circumferential surface of the upper and lower molds 90A and the magnets 62A is discharged as illustrated with a dash-lined arrow in an enlarged view of FIG. 2 from a vicinity of the protrusions 901A to an exhaust hole 902A provided in the upper and lower molds 90A. As a result, it is possible to suppress the deterioration or peeling of the resin which may be caused by an air pocket.

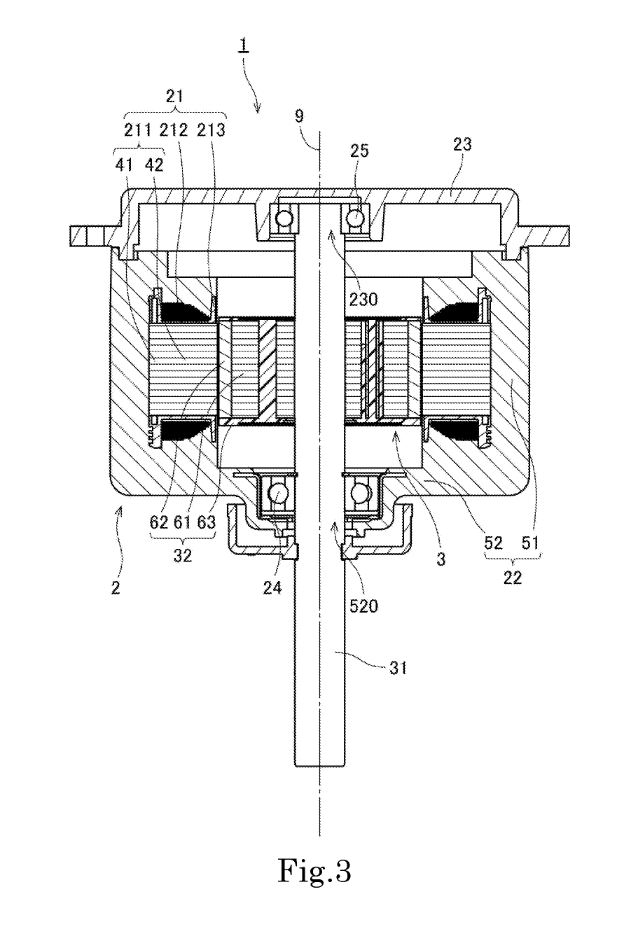

FIG. 3 is a vertical cross-sectional view of a motor 1 according to a second exemplary embodiment. This motor 1 is a so-called inner rotor type motor in which a rotor 32 is provided on a radially inner side of a stator 21. The motor 1 is used, for example, in consumer electronics such as an air conditioner, or the like. The motor of the present disclosure may also be used for applications other than consumer electronics. For example, the motor of the present disclosure may be mounted on transport equipment such as automobiles and railroads, office automation equipment, medical equipment, tools, large-scale industrial facilities, or the like, to generate various driving force.

As illustrated in FIG. 3, the motor 1 includes a stationary portion 2 and a rotary portion 3. The stationary portion 2 is fixed to a frame body of a device to be driven. The rotary portion 3 is rotatably supported by the stationary portion 2.

The stationary portion 2 includes the stator 21, a stator housing 22, a cover member 23, a lower bearing portion 24 and an upper bearing portion 25.

The stator 21 is an armature which generates magnetic flux in response to a drive current. The stator 21 includes a stator core 211 and a conductive wire 212. The stator core 211 is made of a laminated steel plate, which is a magnetic material. The stator core 211 includes a core back 41 and a plurality of teeth 42. The core back 41 surrounds a center axis 9. The plurality of teeth protrudes radially inward from the core back 41. The core back 41 is disposed substantially coaxially with the center axis 9. The plurality of teeth 42 are arranged at substantially identical intervals in the circumferential direction. The conductive wire 212 is wound around the plurality of teeth 42. Further, a resin insulator 213 is interposed between the teeth 42 and the conductive wire 212.

The stator housing 22 is a resin member that holds the stator 21. The stator housing 22 is made of, for example, a thermosettable unsaturated polyester resin. The stator housing 22 is obtained by pouring resin into a cavity portion inside the mold in which the stator 21 is accommodated, and solidifying the resin. That is, the stator housing 22 is a resin-molded article having the stator 21 as an insert component. Accordingly, at least a portion of the stator core 211 and the conductive wires 212 is covered by the stator housing 22.

The stator housing 22 of this embodiment includes a cylindrical portion 51 and a bottom plate portion 52. The cylindrical portion 51 axially extends in a substantially cylindrical shape. The stator 21 is covered by the resin that forms the cylindrical portion 51. However, a portion of the stator 21 including a radially inner end surface of the teeth 42 may be exposed through the cylindrical portion 51. Further, the rotor 32, which will be described in detail in a subsequent section, is provided on a radially inner side of the cylindrical portion 51. The bottom plate portion 52 expands substantially perpendicularly to the center axis 9 on an axially lower side than the stator 21 and the rotor 32. An insertion hole 520, through which a shaft 31, which will be described in detail in a subsequent section, penetrates, is provided at the center of a lower surface of the bottom plate portion 52. The lower bearing portion 24 is provided around the insertion hole 520.

The cover member 23 is a disc-shaped member which closes an opening on a top portion of the stator housing 22. The cover member 23 expands substantially perpendicularly to the center axis 9 on an axially upper side than the stator 21 and the rotor 32. A bearing accommodation portion 230 having a concave shape is provided at the center of a lower surface of the cover member 23. The upper bearing portion 25 and the upper end portion of the shaft 31 are provided within the bearing accommodation portion 230.

The lower bearing portion 24 rotatably supports the shaft 31 from an axially lower side than the rotor 32. The upper bearing portion 25 rotatably supports the shaft 31 on an axially upper side than the rotor 32. A ball bearing having a plurality of spherical bodies between an outer ring and an inner ring is used in the lower bearing portion 24 and the upper bearing portion 25 of this embodiment. An outer ring of the lower bearing portion 24 is fixed to the bottom plate portion 52 of the stator housing 22. An outer ring of the upper bearing portion 25 is fixed to the cover member 23. Further, inner rings of the lower bearing portion 24 and the upper bearing portion 25 are fixed to an outer circumferential surface of the shaft 31. Also, instead of the ball bearing, other types of bearing, such as a sliding bearing, a liquid bearing, or the like, may be used.

The rotary portion 3 includes the shaft 31 and the rotor 32.

The shaft 31 is a columnar member provided along the center axis 9. The shaft 31 is supported by the lower bearing portion 24 and the upper bearing portion 25, and rotates on the center axis 9. The lower end of the shaft 31 protrudes below the lower bearing portion 24. A fan for an air conditioner, for example, is mounted on the lower end of the shaft 31. The shaft 31 may be connected to a drive unit other than the fan via a power transmission mechanism, such as a gear, or the like.

Further, although it has been described that the shaft 31 of this embodiment protrudes below the stator housing 22, the present disclosure is not limited thereto. The upper end of the shaft 31, which protrudes above the cover member 23, may be connected to the drive unit. Further, the upper end and the lower end of the shaft 31, which respectively protrude above the cover member 23 and below the stator housing 22, may both be connected to the drive unit.

The rotor 32 is fixed to the shaft 31, and rotates together with the shaft 31. An outer circumferential surface of the rotor 32 radially faces a radially inner end surface of the plurality of teeth 42 across a slight gap. The rotor 32 includes a tube-shaped rotor core 61, a plurality of magnets 62 and a resin portion 63.

An electromagnetic steel plate, which is a magnetic material, is used in the rotor core 61. The shaft 31 is press-fitted into a radially inner side of the rotor core 61, and vertically penetrates the rotor core 61. The plurality of magnets 62 are provided on an outer circumferential surface of the rotor core 61. A radially outer side surface of each of the magnets 62 is a magnetic pole surface of either an N pole or an S pole, and radially faces a radially inner end surface of the teeth 42. The plurality of magnets 62 are arranged at substantially identical intervals in the circumferential direction, such that the magnetic pole surface having an N pole and the magnetic pole surface having an S pole are alternately arranged. The resin portion 63 covers the rotor core 61 and the magnets 62, and is a so-called mold resin. By being covered with the resin portion 63, the rotor core 61 and the magnets 62 are supported without being misaligned from each other.

When the motor 1 is driven, driving voltage is supplied from an external power source to the conductive wire 212 of the stator 21 via a circuit board, which is not illustrated in the drawings. Then, magnetic flux is generated in the plurality of teeth 42 of the stator core 211. Then, a torque in the circumferential direction is generated by an action of the magnetic flux between the teeth 42 and the magnets 62. As a result, the rotary portion 3 rotates on the center axis 9.

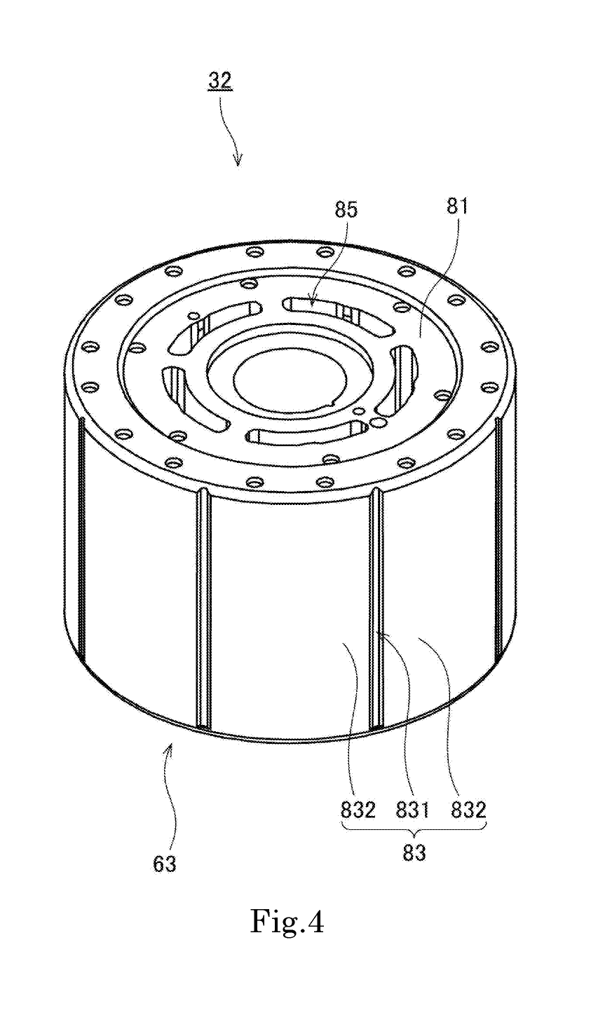

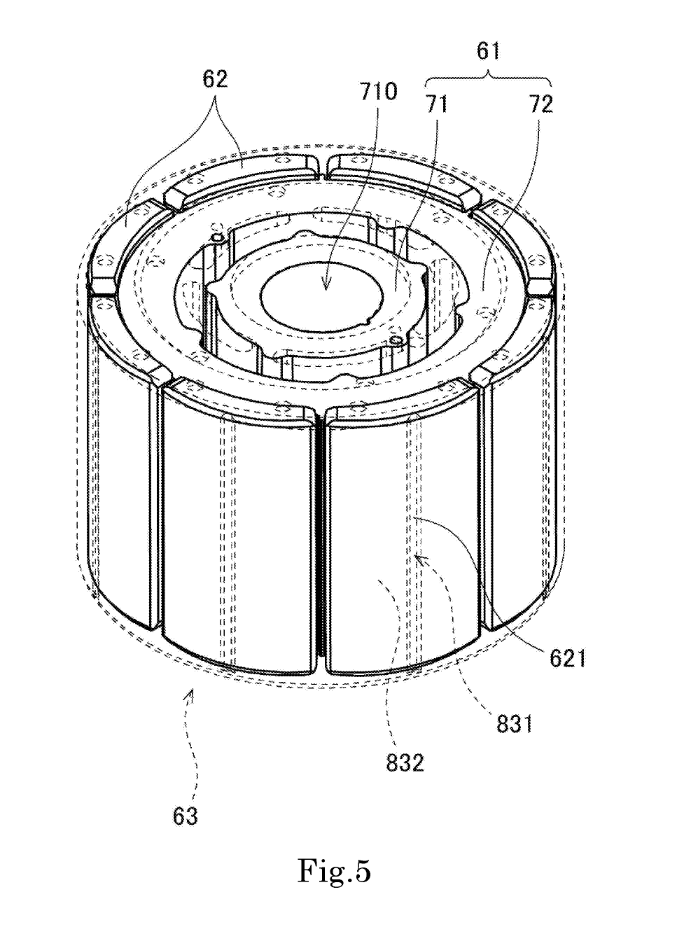

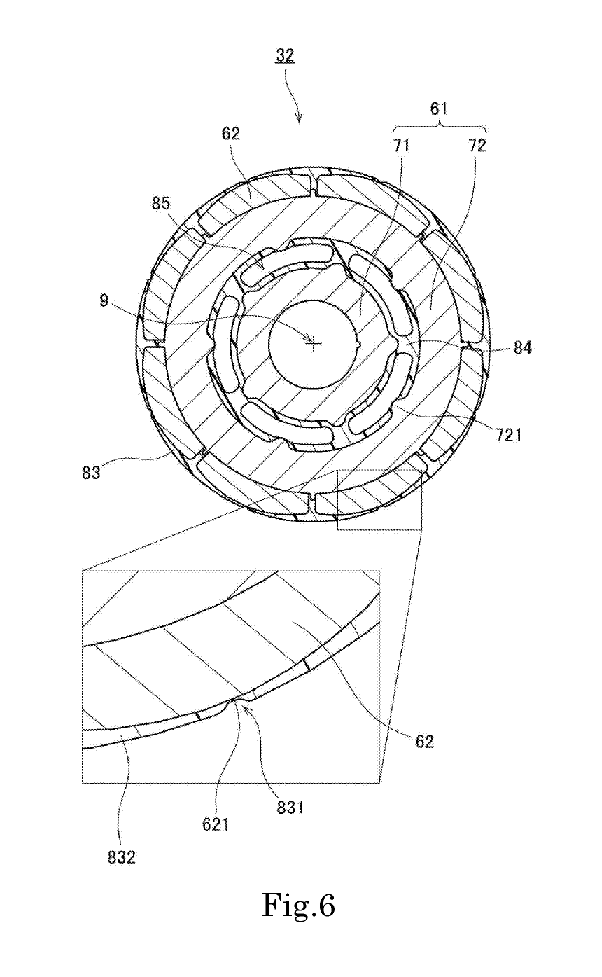

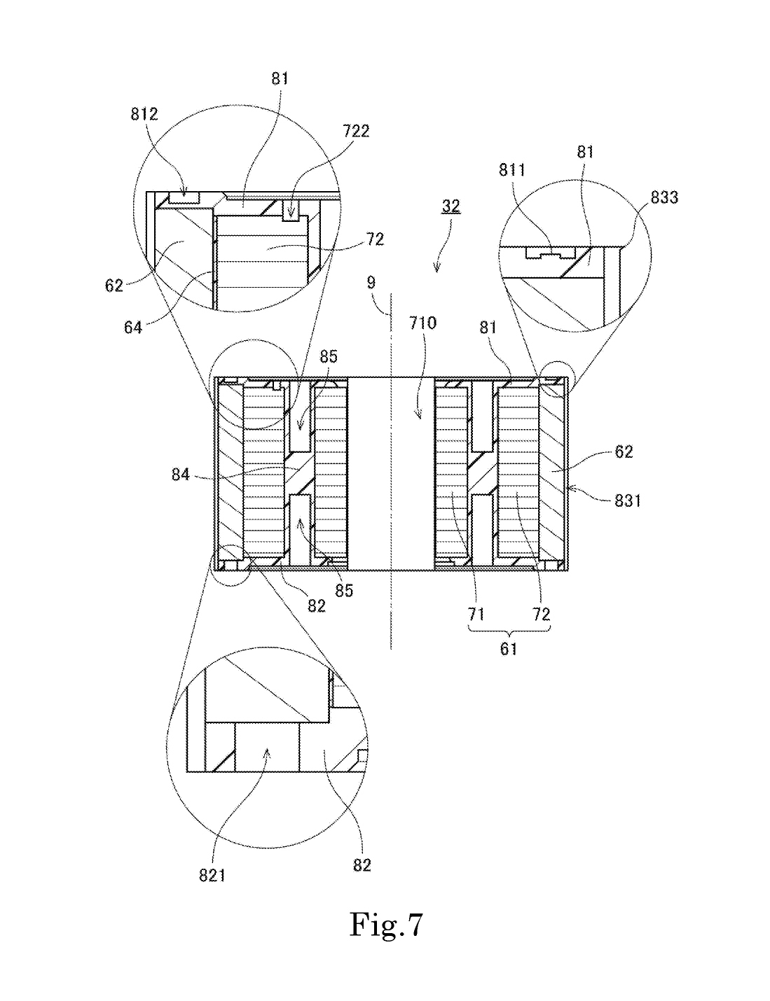

Continuously, a further detailed structure of the rotor 32 will be explained. FIG. 4 is a perspective view of the rotor 32. FIG. 5 is a perspective view of the rotor core 61 and the plurality of magnets 62. In FIG. 5, the shape of the resin portion 63 is illustrated with a dashed line. FIG. 6 is a cross-sectional view of the rotor 32. FIG. 7 is a vertical cross-sectional view of the rotor 32.

As illustrated in FIG. 5 to FIG. 7, the rotor core 61 of this embodiment includes an inner core 71 and an outer core 72. Both the inner core 71 and the outer core 72 axially extend in a substantially cylindrical shape. Further, the outer core 72 is disposed on a radially outer side than the inner core 71. An axially penetrating central hole 710 is provided at the center of the inner core 71. The shaft 31 is press-fitted into the central hole 710 of the inner core 71. With this, the shaft 31 and the inner core 71 are fixed to each other.

The plurality of magnets 62 are provided on an outer circumferential surface of the outer core 72. A radially inner side surface of each of the magnets 62 is formed of a substantially arc-shaped surface having its center on the center axis 9. Accordingly, a distance from the center axis 9 to the radially inner side surface of the magnets 62 is substantially constant, regardless of their circumferential position. Meanwhile, a radially outer side surface of each of the magnets 62 is formed of a substantially arc-shaped surface having a smaller radius of curvature than that of the radially inner side surface. A distance from the center axis 9 to the radially outer side surface of the magnets 62 gradually becomes shorter from the circumferential center toward both circumferential end portions. Accordingly, the magnets 62 of this embodiment have an apex portion 621, which has the farthest distance from the center axis 9, at the circumferential center of the radially outer side surface.

As illustrated in FIG. 4 to FIG. 7, the resin portion 63 of this embodiment includes an upper cover portion 81, a lower cover portion 82, an outer cover portion 83 and a core connection portion 84. The upper cover portion 81 is disposed on an axially upper side than the rotor core 61 and the plurality of magnets 62, and expands perpendicularly to the center axis 9. An upper surface of the rotor core 61 and an upper surface of the plurality of magnets 62 are covered by the upper cover portion 81. The lower cover portion 82 is disposed on an axially lower side than the rotor core 61 and the plurality of magnets 62, and expands perpendicularly to the center axis 9. A lower surface of the rotor core 61 and a lower surface of the plurality of magnets 62 are covered by the lower cover portion 82.

The outer cover portion 83 expands in the axial direction between a radially outer edge portion of the upper cover portion 81 and a radially outer edge portion of the lower cover portion 82. A radially outer side surface of the plurality of magnets 62 is covered by the outer cover portion 83. As illustrated in FIG. 4 to FIG. 6, the outer cover portion 83 of this embodiment includes a plurality of groove portions 831 and a plurality of wall portions 832. The plurality of groove portions 831 is disposed on a radially outer side of each of the plurality of magnets 62. Each of the groove portions 831 is concaved radially inward from a radially outer side surface of the outer cover portion 83. Further, the groove portions 831 of this embodiment axially extend from an upper end of the outer cover portion 83 to a lower end thereof. A portion of the radially outer side surface of the magnets 62, which radially overlaps with the groove portions 831, may be exposed in the groove portions 831, or may be covered with a thin resin film.

The wall portions 832 are arranged adjacent to both circumferential sides of each of the grove portions 831. Each of the wall portions 832 axially and circumferentially expands along a radially outer side surface of the magnets 62. When the motor 1 is driven, large centrifugal force is applied to the magnets 62. However, since the radially outer side surface of the magnets 62 is covered by the wall portion 832, the magnet 62 is prevented from scattering out to a radially outer side. Especially, in the rotor 32 of this exemplary embodiment, a circumferential width of the groove portions 831 is narrower than a circumferential width of the wall portions 832. By expanding the circumferential width of the wall portions 832 this way, it is possible to further prevent the magnets 62 from scattering out to a radially outer side.

Further, as illustrated as an enlarged view in FIG. 7, in this embodiment, an adhesive 64 is interposed between an outer circumferential surface of the outer core 72 and the magnets 62. For this reason, not only a supporting strength of the wall portions 832 but also an adhesive strength of the adhesive 64 contributes to the scatter-prevention of the magnets 62.

The core connection portion 84 is interposed between the inner core 71 and the outer core 72. The inner core 71 and the outer core 72 are connected by the core connection portion 84. In the rotor 31 of this embodiment, the inner core 71 is directly fixed to the shaft 31, not via the resin portion 63. For this reason, it is possible to increase a fixing strength between the shaft 31 and the rotor core 61 as compared to a case in which the rotor core 61 is fixed to the shaft 31 via the resin portion 63. Further, the core connection portion 84, which is an insulating material, is interposed between the inner core 71 and the outer core 72. Accordingly, a conductor group including the magnets 62 and the outer core 72 and a conductor group including the inner core 71, the shaft 31, the lower bearing portion 24 and the upper bearing portion 25 are electrically insulated. With this, when the motor 1 is driven, it is possible to suppress the damage which may occur in the lower bearing portion 24 and the upper bearing portion 25 due to electrolytic corrosion phenomenon.

Further, as illustrated in FIG. 4, FIG. 6 and FIG. 7, the resin portion 63 of this embodiment has axially concaved apertures 85 respectively on an upper side and a lower side of the core connection portion 84. For this reason, the core connection portion 84 and an air layer having a lower conductivity than the resin are interposed between the Inner core 71 and the outer core 72. With this, the inner core 71 and the outer core 72 are further electrically insulated. Further, the amount of resin used is reduced by forming the apertures 85. Furthermore, as illustrated in FIG. 4 and FIG. 6, a plurality of apertures 85 is arranged in the circumferential direction in this embodiment. However, the apertures 85 may be connected into an annular shape.

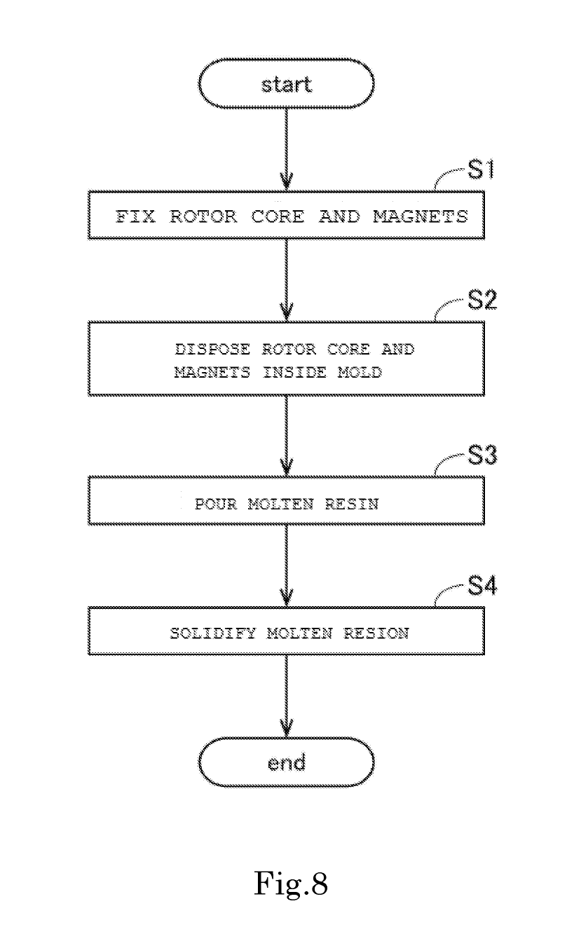

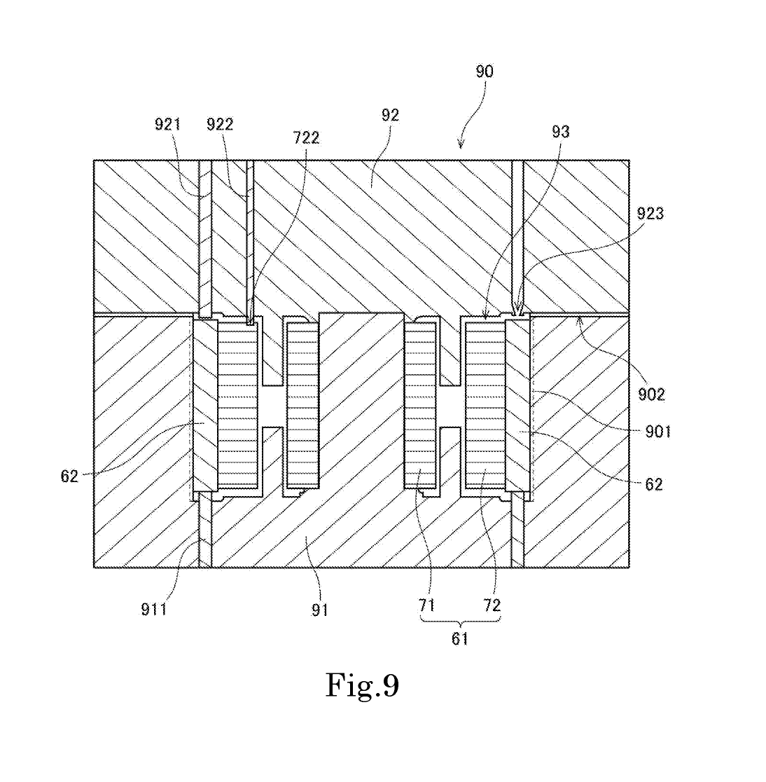

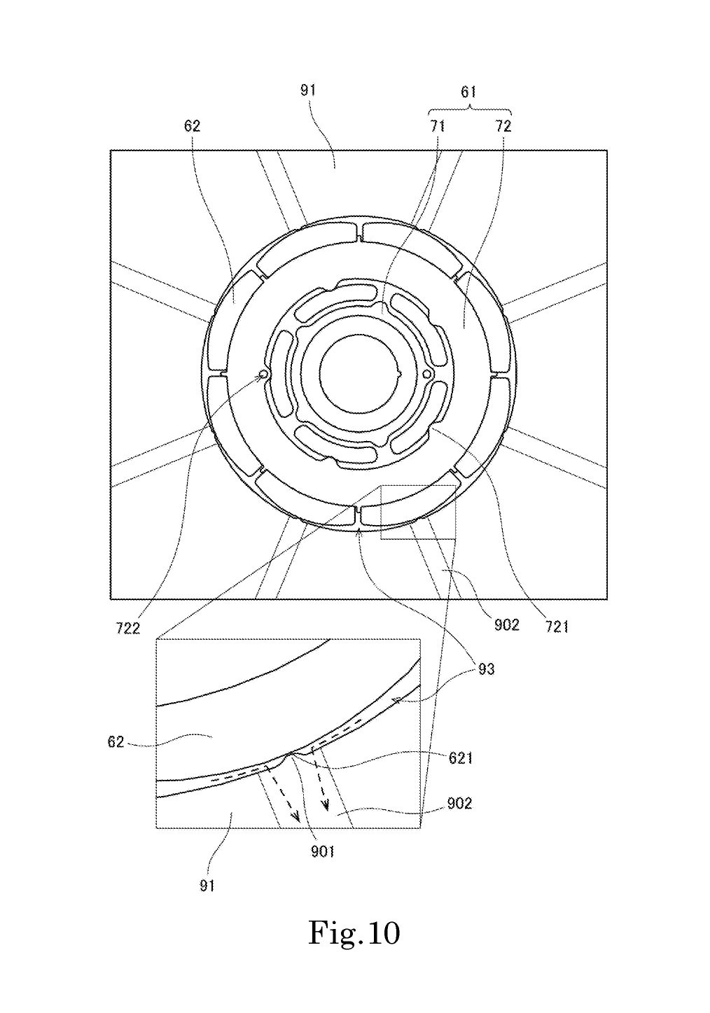

Continuously, a manufacturing sequence of the rotor 32 will be described. FIG. 8 is a flowchart which illustrates the manufacturing sequence of the rotor 32. FIG. 9 is a vertical cross-sectional view of a state when injection molding is performed. FIG. 10 is a top view of a state when injection molding is performed.

When manufacturing the rotor 32, first, the inner core 71, the outer core 72 and the plurality of magnets 62 are prepared. Then, the plurality of magnets 62 are fixed to an outer circumferential surface of the outer core 72 by the adhesive 64 (Step S1). It should be noted that, if it is possible to fix the outer core 72 and the plurality of magnets 62 in the next step S2, by the shape of a lower mold 91 or with a pin such that the outer core and the magnets are in contact with each other, then the fixing by the adhesive 64 in Step 1 may be omitted.

Next, the inner core 71, the outer core 72 and the plurality of magnets 62 are disposed inside upper and lower molds 90 to be used for resin molding (Step S2). The upper and lower molds 90 include the inner core 71, the outer core 72, a lower mold 91 and an upper mold 92. The lower mold 91 receives the plurality of magnets 62. The upper mold 92 closes an opening on the top portion of the lower mold 91. In this embodiment, the outer core 72 and the plurality of magnets 62 are adhered in advance during Step S1. For this reason, in Step S2, the outer core 72 and the plurality of magnets 62 can be easily disposed inside the lower mold 91.

After placing the rotor core 61 and the plurality of magnets 62 inside the lower mold 91, when a lower surface of the upper mold 92 is brought into contact with an upper surface of the lower mold 91, a cavity portion 93 is formed inside the upper and lower molds 90 as illustrated in FIG. 9. Further, the inner core 71, the outer core 72 and the plurality of magnets 62 are accommodated in the cavity portion 93.

As illustrated in FIG. 9, a plurality of positioning pins 911 is provided in the lower mold 91. An upper end of each of the positioning pins 911 is in contact with a lower end surface of the magnets 62. With this, the outer core 72 and the plurality of magnets 62 are positioned in the axial direction. It should be noted that, the outer core 72 and the plurality of magnets 62 may be positioned in the axial direction by bringing the upper end of the positioning pins 911 in contact with a lower end surface of the outer core 72.

Further, as illustrated in FIG. 9, a plurality of uplift prevention pins 921 is provided in the upper mold 92. A lower end of each of the uplift prevention pins 921 axially faces an upper end surface of the magnets 62 across a slight gap. With this, in Step S3, which will be described in a subsequent section, uplifting of the outer core 72 and the plurality of magnets 62 is suppressed by a pressure of the molten resin. Furthermore, uplifting of the outer core 72 and the plurality of magnets 62 may be suppressed by configuring the lower end of the uplift prevention pin 921 to face the upper end surface of the outer core 72.

Further, as illustrated as an enlarged view in FIG. 10, the lower mold 91 has a plurality of protrusions 901. Each of the plurality of protrusions 901 is disposed on a radially outer side of the apex portion 621 of the magnets 62. Furthermore, each of the protrusions 901 protrudes radially inward from an inner circumferential surface which defines the cavity portion 93 of the lower mold 91, while extending in the axial direction. When the inner core 71, the outer core 72 and the plurality of magnets 62 are disposed inside the lower mold 91, the plurality of protrusions 901 contact or radially face each of the radially outer side surfaces of the plurality of magnets 62 across a slight gap.

The outer core 72 includes a plurality of convex portions 721 protruding radially inward on an inner circumferential surface thereof. When disposing the outer core 72 in the lower mold 91, a positioning jig is brought into contact with the convex portions 721. With this, the outer core 72 is positioned in the circumferential direction. As a result, the apex portion 621 of each of the magnets 62 is arranged to face the protrusions 901 of the lower mold 91.

Further, as illustrated in FIG. 9 and FIG. 10, the outer core 72 has a recessed portion 722 provided on an upper surface thereof. Meanwhile, a rotation prevention pin 922 is provided in the upper mold 92. In Step S2, a lower end of the rotation prevention pin 922 is inserted into the recessed portion 722 of the outer core 72. With this, a circumferential displacement of the outer core 72 is prevented. As a result, a position of the apex portion 621 each of the magnets 62 is maintained at a position facing the protrusions 901 of the lower mold 91. It should be noted that, the outer core 72 may be configured to have a recessed portion provided on a lower surface thereof, and the rotation prevention pin provided in the lower mold 91 may be inserted into said recessed portion.

As illustrated in FIG. 9, in this embodiment, an interface between the lower mold 91 and the upper mold 92 is positioned on an axially upper side than the magnets 62. Further, as illustrated in FIG. 9 and FIG. 10, a plurality of exhaust holes 902 which extend in the radial direction are formed at a boundary between the lower mold 91 and the upper mold 92. Each of the exhaust holes 902 extends radially outward from a vicinity of an upper end portion of the protrusions 901. Accordingly, a radially inner end portion of each of the exhaust holes 902 axially and circumferentially overlaps with the protrusions 901.

Next, from a resin injection port 923 which is provided in the upper mold 92, molten resin is poured into the cavity portion 93 inside the upper and lower molds 90 (Step S3). In this embodiment, the resin injection port 923 is disposed in a position facing an upper end surface of the magnets 62. More specifically, the resin injection port 923 is disposed in a circumferential position substantially identical with the protrusions 901 of the lower mold 91 and the apex portion 621 of the magnet 62. Accordingly, the molten resin injected from the resin injection port 923 flows from a vicinity of a circumferential center of the magnets 62, which has a relatively narrow distance between the upper and lower molds 90, toward a vicinity of both circumferential end portions of the magnets 62, which has a relatively wide distance between the upper and lower molds 90. With this, it becomes easier to exhaust the air inside the upper and lower molds 90, and it thereby becomes easier to spread the molten resin in the entire cavity portion 93. Further, the resin injection port 923 may be provided in the lower mold 91.

As indicated with a dashed arrow in an enlarged view of FIG. 10, the molten resin is introduced from the both sides in the circumferential direction toward the protrusions 901, in between a radially outer surface of the magnets 62 and an inner circumferential surface of the lower mold 91. Since the gap between a vicinity of the apex portion 621 of the magnets 62 and the inner circumferential surface of the lower mold 91 is particularly narrow, if the protrusions 901 do not exist, an air pocket is likely to remain in that space. However, in this embodiment, by the protrusions 901 of the lower mold 91, the space between the vicinity of the apex portion 621 of the magnets 62 and the inner circumferential surface of the lower mold 91 is made smaller. Accordingly, it is difficult for an air pocket to remain between the radially outer side surface of the magnets 62 and the inner circumferential surface of the lower mold 91. The air in the vicinity of the protrusions 901 is pushed upward, and thereby exhausted to the outside through the exhaust holes 902 as indicated with a dashed-line arrow in the enlarged view of FIG. 10. As a result, it is possible to suppress the deterioration or peeling of the resin which may be caused by the air pocket.

When the molten resin has spread out in the cavity portion 93 inside the upper and lower molds 90, the process is followed by a step of solidifying the molten resin (Step S4). With this, the resin portion 63 including the upper cover portion 81, the lower cover portion 82, the outer cover portion 83 and the core connection portion 84 is formed. Further, when the molten resin is solidified, the inner core 71, the outer core 72 and the plurality of magnets 62 are fixed together by the resin portion 63.

In Step S3, the groove portion 831 is formed on the outer cover portion 83 by the plurality of protrusions 901 of the lower mold 91. In this embodiment, the groove portion 831 is formed on a radially outer side of the apex portion 621 of the magnets 62. Further, the groove portion 831 of this embodiment extends from an upper end of the outer cover portion 83 to a lower end thereof in the axial direction. It should be noted that the groove portion 831 of this embodiment does not necessarily need to extend from the upper end of the outer cover portion 83 to the lower end thereof in the axial direction. However, in order to easily release the resin portion 63 from the upper and lower molds 90 after solidification, it is possible for the groove portion 831 to axially extend from at least one of the upper end and the lower end of the outer cover portion 83.

Further, as illustrated in the enlarged view of FIG. 7, the molded resin portion 63 has a gate mark 811 on the upper surface of the upper cover portion 81. The gate mark 811 is a trace of the resin injection port 923. In this embodiment, the gate mark 811 and the groove portion 831 are disposed in a substantially identical circumferential position. Furthermore, as described above, the resin injection port 923 may be provided in the lower mold 91. In this case, the gate mark is formed on a lower surface of the lower cover portion 82.

Further, as illustrated in the enlarged view of FIG. 7, the molded resin portion 63 has a parting line 833 on an upper end of the outer cover portion 83. The parting line 833 is a trace of the interface between the lower mold 91 and the upper mold 92. The parting line 833 and the groove portions 831 are connected to each other. Furthermore, in this embodiment, the parting line 833 is positioned on an axially upper side than the magnets 62 and the stator core 211. For this reason, even if a minute protrusion is generated on the parting line 833, it is possible to inhibit such minute protrusion or a resin fragment chipped off from said minute protrusion from contacting the teeth 42 of the stator core 211.

Further, the interface between the lower mold 91 and the upper mold 92 may be positioned on an axially lower side than the magnets 62 and the stator core 211. In this case, the parting line 833 is positioned on a further axially lower side than the magnets 62 and the stator core 211. For example, the parting line 833 is formed on a lower end of the outer cover portion 83.

Further, as illustrated in the enlarged view of FIG. 7, the molded resin portion 63 has a concave portion 812, which is recessed toward a lower side thereof, on an upper surface of the upper cover portion 81. The concave portion 812 is a trace of the plurality of uplift prevention pins 921 of the upper mold 92. Accordingly, when seen in a top view, the concave portion 812 is provided in a position overlapping with the magnets 62. When the uplift prevention pin 921 is provided above the outer side core 72, the concave portion 812 is formed in a position overlapping with the outer core 72 when seen in a top view.

Further, as illustrated in the enlarged view of FIG. 7, the molded resin portion 63 includes a plurality of through holes 821 in the lower cover portion 82. The through holes 821 are traces of the plurality of positioning pins 911 of the lower mold 91. Accordingly, when seen in an underside view, the through holes 821 are disposed in a position overlapping with the magnets 62. However, when the positioning pins 911 are provided below the outer core 72, the through holes 821 are formed in a position overlapping with the outer core 72 when seen in an underside view.

Although the exemplary embodiments of the present disclosure have been described, the present disclosure is not limited thereto.

In the above-described exemplary embodiments, the radially outer side surface of the magnets has a curved surface bulging radially outward. For this reason, the apex portion thereof is positioned in a circumferential center of the radially outer side surface of the magnets. However, the radially outer side surface of the magnets may have a different shape as long as a distance from the center axis changes depending on a circumferential position. For example, the radially outer side surface of the magnets may have a curved surface which is concaved radially inward. That is, the apex portion may be provided on both circumferential end portions of the radially outer side surface of the magnets. In this case, it is possible for the resin portion to have the groove portions in a position radially overlapping with both circumferential end portions of the magnets.

Further, in the exemplary embodiments, the protrusions that define the groove portions are provided only in the lower mold. When the interface between the upper and lower molds is positioned on a lower side than the upper end portion of the magnets, the protrusions that define the groove portions may be provided in both of the lower mold and the upper mold, or only in the upper mold.

Features of the above-described embodiments and the modifications thereof may be combined appropriately as long as no conflict arises. While embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A rotor which is used in an inner rotor type motor and rotates on a vertically extending center axis, the rotor comprising:
a cylindrical rotor core comprising a magnetic material;
a plurality of magnets provided on an outer circumferential surface of the rotor core; and
a resin portion holding the rotor core and the magnets, the resin portion comprising an outer cover portion covering a radially outer side surface of the magnets,
wherein the outer cover portion comprises:
a groove portion recessed radially inward from a radially outer surface and extending in an axial direction; and
a wall portion adjacent to the groove portion in a circumferential direction.

2. The rotor of claim 1,
wherein a circumferential width of the groove portion is narrower than a circumferential width of the wall portion.

3. The rotor of claim 1,
wherein a distance from the center axis to the radially outer side surface of the magnets varies depending on a circumferential position,
the magnets have an apex portion on the radially outer side surface at a farthest position from the center axis, and
the groove portion is positioned at least on a radially outer side of the apex portion.

4. The rotor of claim 3,
wherein the apex portion is positioned in a circumferential center of the magnets.

5. The rotor of claim 1,
wherein the groove portion axially extends from at least one of an upper end and a lower end of the outer cover portion.

6. The rotor of claim 5,
wherein the groove portion axially extends from the upper end to the lower end of the outer cover portion.

7. The rotor of claim 5,
wherein the outer cover portion has a parting line on the upper end or the lower end thereof, the parting line connected to the groove portion.

8. The rotor of claim 6,
wherein the outer cover portion has a parting line on the upper end or the lower end thereof, the parting line connected to the groove portion.

9. The rotor of claim 7,
wherein the parting line is positioned on an axially upper side or an axially lower side than the magnets.

10. The rotor of claim 1,
wherein an adhesive is interposed between an outer circumferential surface of the rotor core and the magnets.

11. The rotor of claim 1,
wherein an upper surface or a lower surface of the resin portion has a gate mark which is a trace of a resin injection port of a mold, the gate mark arranged in a circumferential position that is identical with the groove portion.

12. The rotor of claim 1,
wherein the rotor core comprises:
a cylindrical inner core; and
a cylindrical outer core positioned on a radially outer side than the inner core, the plurality of magnets provided on an outer circumferential surface of the outer core, and
wherein the resin portion comprises:
a core connection portion interposed between the inner core and the outer core.

13. The rotor of claim 12,
wherein the outer core comprises a radially inwardly protruding convex portion.

14. The rotor of claim 12,
wherein the outer core comprises a recessed portion on an upper surface or a lower surface thereof.

15. The rotor of claim 1,
wherein the resin portion further comprises an upper cover portion which covers an upper surface of the rotor core and an upper surface of the magnet, and
the upper cover portion comprises a plurality of concave portions which are recessed downward from the upper surface, the concave portions overlapping with the rotor core or the magnet, when seen in a top view.

16. The rotor of claim 1,
wherein the resin portion further comprises a lower cover portion which covers a lower surface of the rotor core and a lower surface of the magnet, and
the lower cover portion comprises a plurality of vertically penetrating through holes, the through holes overlapping with the rotor core or the magnet, when seen in an underside view.

17. An inner rotor type motor, comprising:
a rotor structured to rotate on a vertically extending center axis, the rotor comprising:
a cylindrical rotor core comprising a magnetic material;
a plurality of magnets provided on an outer circumferential surface of the rotor core; and
a resin portion holding the rotor core and the magnets, the resin portion comprising an outer cover portion covering a radially outer side surface of the magnets,
wherein the outer cover portion comprises:
a groove portion recessed radially inward from a radially outer surface and extending in an axial direction; and
a wall portion adjacent to the groove portion in a circumferential direction;
a stator core formed of a magnetic material having a plurality of teeth which face an outer circumferential surface of the rotor in a radial direction;
a conductive wire wound around the plurality of teeth; and
a stator housing which is made of resin and covers at least a portion of the conductive wire and the stator core.

18. A method of manufacturing a rotor having a tube-shaped rotor core which is made of a magnetic material and has its center on a vertically extending center axis; a plurality of magnets which are provided on an outer circumferential surface of the rotor core; and a resin portion which holds the rotor core and the magnets,
the method comprising:
a) disposing the rotor core and the plurality of magnets in a cavity portion formed by a pair of upper and lower molds;
b) pouring molten resin into the cavity portion; and
c) forming the resin portion by solidifying the molten resin,
wherein at least one of the pair of upper and lower molds includes a plurality of protrusions which protrude radially inward on an inner circumferential surface that defines the cavity portion, while extending in an axial direction,
in step a), the plurality of protrusions contact each radially outer side surface of the plurality of magnets or radially face the radially outer side surface of the plurality of magnets across a slight gap, and
in step c), a groove portion is formed in the resin portion by the plurality of protrusions.

19. The method of claim 18,
wherein, in step a), an exhaust hole is formed between the pair of upper and lower molds, a radially inner end portion of the exhaust hole axially and circumferentially overlapping with the protrusions.

20. The method of manufacturing of claim 18,
wherein, in step a), a plurality of exhaust holes are formed between the pair of upper and lower molds, each radially inner end portion of the plurality of exhaust holes axially and circumferentially overlapping with the protrusions.

21. The method of claim 18,
wherein an interface between the pair of upper and lower molds is positioned on an axially upper side or an axially lower side than the magnets.

22. The method of claim 18,
wherein, in step a), a front end of an uplift prevention pin provided in the molds axially faces the rotor core or an axial end surface of the magnets.

23. The method of manufacturing of claim 18,
wherein, in step a), a front end of a positioning pin provided in the molds contacts the rotor core or an axial end surface of the magnets.
